(19) United States
(12) Patent Application Publication
(10) Pub. No.: US 2011/0082805 A1
(43) Pub. Date: Apr. 7, 2011

(54) METHOD FOR DISCOVERING DRUGS

(76) Inventor: MARTIN ALEXANDER HAY, PRESTBURY (GB)

(21) Appl. No.: 12/884,249

(22) Filed: Sep. 17, 2010

Related U.S. Application Data
(60) Provisional application No. 61/247,713, filed on Oct. 1, 2009.
(60) Provisional application No. 61/248,569, filed on Oct. 5, 2009.

(51) Int. Cl. G06Q 50/00

(52) U.S. Cl. 705/310

(57) ABSTRACT

A method of creating patent rights for a business entity in a drug candidate for clinical development, in which an expert in pharmaceutical science and an expert in pharmaceutical patent law collaborate in a risk-free environment to identify and protect drug candidates, and a kit useful in the method.

This application claims the benefit of U.S. provisional patent application number 61247,713 filed on Oct. 1, 2009 and U.S. provisional patent application number 61248,569 filed on Oct. 5, 2009, the contents of which are incorporated herein by reference in their entirety.

After the second provisional application was filed, the contents were communicated to third parties without attaching any condition of confidentiality. However, the present invention is believed to be fully entitled to priority.

The present invention relates to a method useful in the research-based pharmaceutical industry in the course of the discovery and development of medicinal products. More particularly it relates to a method of identifying a patentable candidate for clinical development as a drug.

Methods useful in the discovery of medicinal products are known in the patent literature. See, for example U.S. Pat. No. 6,656,694 and EP 1350108B1, in both of which the Applicant acted as agent/attorney.

In pursuing the present application, Applicant is seeking to engage both with those using and with those administering the patent system to contribute to the creation of new jobs and improvement in healthcare by stimulating innovation in the pharmaceutical industry. The invention concerns the process of innovation itself, and includes a way of using the global patent system in the course of discovery research. It draws upon Applicant's experience accumulated over many years of practice. It challenges conventional wisdom about what innovation actually is, questions whether use of the patent system is being regulated in a way that now actually inhibits innovation and addresses what functions those using and those administering the patent system need to perform to promote innovation. More particularly, it challenges the assumption that innovation is a purely technical process best served by regulating those skilled in patent practice as professional representatives for technical inventors, rather than as other innovators.

The research-based pharmaceutical industry discovers, develops, manufactures and sells medicinal products. A medicinal product comprises one or more drugs, which are biologically active compounds, and optionally one or more pharmaceutically acceptable carriers (as in a pharmaceutical composition such as a tablet), and/or a delivery device (such as an inhaler). It can be thought of as an embodiment of a solution to a technical, or more particularly a medical problem. The problem may be, for example, a disease requiring treatment. The solution comprises all of the information required to actually enable the public to gain access to treatment. It includes what the medicinal product consists of, how it can be manufactured and how it can be used safely and effectively. Until all of this information has been assembled and the medicinal product brought to the market, the public cannot gain any benefit from it.

The cost of discovering and, especially, developing a new medicinal product is huge. However, it is relatively inexpensive for the generic pharmaceutical industry to manufacture and sell an imitation product. Hence it is critical for the research-based pharmaceutical industry that the manufacture and sale of each new medicinal product is protected from generic competition for a period of time sufficiently long for it to be able to recover the research and development costs and to provide it with an incentive to invest in a new cycle of discovery and development.

Creating protection for a medicinal product is an essential feature of the methods used by the research based pharmaceutical industry in the discovery and development of new medicinal products. Thus, if a medicinal product is a solution to a technical problem, then the products of the discovery and development processes of the research-based pharmaceutical industry are exclusive solutions to technical problems. The innovation that is needed to bring new drugs to patients is actually both a creative technical process and a creative legal process. The creation of exclusive solutions is the engine that drives the creation of new businesses and new jobs.

The research-based pharmaceutical industry relies mainly on the global patent system to provide protection for the medicinal products that it discovers and develops, and primarily on patent protection for the drugs they contain. A patent for a drug confers on its owner the right, for a limited period of time, to exclude others from manufacturing and selling the drug in any form, including in any medicinal product containing it.

Patent protection is afforded to products and processes (including medical uses) that provide solutions to technical problems, which solutions, in the opinion of expert decision-makers operating the global patent system (patent office examiners and patent judges), were neither known nor obvious from what was previously known. (See, for example, PCT Rule 5.1(iii); United States Patent and Trademark Office Manual of Patent Examining Procedure, Chapter 2141; and European Patent Office Guidelines for Substantive Examination C-IV, 9.8). However, in the patent system, the technical problems solved by medicinal products as a whole are not considered, only technical problems that form distinct component parts of the overall problems. For example, the patent system affords protection for the solution to a problem which is to provide a compound that is novel and possesses a non-obvious biological activity. As long as at least one of these component parts is essential to the whole solution (has to be exploited to make, use and sell the drug) then the medicinal product as a whole is provided with exclusivity.

The inability of the patent system to provide protection for drugs as a solution to an overall technical problem restricts the choice of clinical candidates for development. In the patent system, compounds are considered to be known and hence unpatentable if an enabling description of them has been published, even though the public cannot make use of the information to obtain treatment using the compound. The patent system fails to provide any incentive to develop compounds as new drugs whenever it is believed that no patent protection can be obtained for them. In this sense, the patent system is imperfectly adapted to the needs of the pharmaceutical industry, and may at some time in the future need to be replaced or supplemented.

In recent years, the number of new drugs coming to the market has fallen. The European Commission has noted this and has conducted an inquiry into the pharmaceutical sector. The inquiry sought to examine the reasons for observed delays in the entry of generic medicines to the market and the apparent decline in innovation as measured by the number of new medicines coming to the market. In the conclusion to its Final Pharmaceutical Sector Inquiry Report (Jul. 8, 2009), the Commission states that: “The sector inquiry also confirms a decline of novel medicines reaching the market and points to certain company practices that might, amongst other factors, contribute to this phenomenon. Further market monitoring is ongoing trying to identify the additional factors that are likely to play a role in this context.” The Commission has chosen its words with great care, but reading between the lines it appears that the Commission views innovation as a purely technical process driven by price competition, and the pursuit of intellectual property rights as something necessary, but separate: a sort of murky game played by people of sometimes dubious ethics that needs to be strictly regulated. It does not appear to recognise that the emergence and transformation of the “rules” of this game as intellectual property rights are being created, reformed and destroyed, might be essential features of the process of innovation. Shifting areas of uncertainty could be providing opportunities that drive investment and job creation by both originators and generics. Money flows in counter-current to innovation. Consumers are also producers. Competition and innovation are like yin and yang. Each is inseparable from the other, like quantum entangled states.

In the experience of the Applicant, it has been a perceived lack of opportunity to acquire exclusivity that has driven decisions to exclude compounds from development. Drawing on this experience and wishing to contribute to finding a solution to the problem, the undersigned submitted two letters in response to the public consultation of the European Commission. These are posted on the website of the Commission. In the letters, the Applicant proposed to the Commission the creation of a new intellectual property right for pharmaceuticals: a kind of registered development right. If that suggestion were to be taken up, then the present invention would not be needed. It would remove creative legal thinking from the process of innovation. There would be no legal uncertainty. The rules governing competition between innovators and generic producers and between innovators and other innovators would be clear and fixed.

Several reasons unrelated to competition can be identified for the decline in the number of new drugs: the diseases still awaiting effective treatments are complex, which has increased the technical challenge; while increased regulation and exposure to product liability have increased the legal challenge. Furthermore, as described above, the probability of finding compounds that are novel in a patent law sense has decreased.

Businesses have responded to these challenges by growing ever larger, and re-engineering their business processes to increase efficiency. The pace of job losses has been unrelenting. Curiously, however, the industry has remained heavily dependent on start-up businesses to create clinical candidates. Regulation and control stifle innovation.

The industry needs to find a way to increase innovation, so as to increase the flow of new drug candidates for clinical development.

In accordance with the patent system, it is understood that a drug is invented by one or more inventors, who conceive of what the drug is, how it may be made and what it is useful for. Pharmaceutical science experts “invent” compounds and then utilise patent law experts to advise them and seek patent protection for the compounds. The conception of a compound invention can be complete before the properties of the compound that evidence its patentability have been found.

Patent law experts are trained to anticipate and provide an opinion on how a patent examiner or patent judge will process a request for a decision on whether or not a compound is to be provided with patent protection. They advise the pharmaceutical science experts and seek patent protection based upon the information (facts and law) then made available to them. By the time that a patent examiner or patent judge is called upon to take a decision on whether or not a compound is to be provided with patent protection, the information (facts and law) may have changed. More of the properties of the compound may have become known, the compound may have been a commercial success, and sentiment influencing the behaviour of decision makers may have changed. Thus there is a risk that a decision taken by a patent examiner or judge based upon the information available at that time will differ from the decision that a patent law expert would anticipate based upon the information then available. Generally, the reliability of an opinion of a patent expert depends upon the quality and duration of training undertaken by the expert.

Patent law experts are generally subject to external regulation and exposed to liability in the event that they fail to protect inventions to a standard that experts in the law of negligence consider to be a “reasonable” standard. For example, they can be found to have failed to correctly define the invention, failed to provide an enabling description of the invention, amended the patent specification or claims in a manner that has improperly introduced new matter, determined inventorship incorrectly, failed to meet a due date, failed to satisfy a requirement to disclose information to a patent examiner, etc. This is especially the case if they work in private practice, and such experts will generally need to take out professional indemnity insurance. However, even when working in-house, they are still expected to act as advisers, not decision-makers, and are held to account for their advice. In-house patent attorneys and their departments may find themselves punished by the business if they are perceived to have failed to anticipate that a compound taken into clinical development would eventually be denied patent protection by a patent examiner or patent judge (for example following litigation in which a generic company challenged patent validity). They are also exposed to the risk of sanctions imposed by their professional regulatory body or bodies if they are found to have acted in a manner judged to have been unacceptable. In the known methods for discovering drugs, patent law experts are under a duty of care to protect the patent rights arising in the course of performance of the method, even when they are providing research guidance or are actually co-inventors or co-owners of the business.

In reality, the discovery and development of new drugs is affected by technical and patent risk. The properties of compounds, and the final decisions of patent office examiners and patent judges, are both unpredictable. The action of a CNS drug on a living system and the action of sensory input on the brain of a patent judge share a common mechanism!

The creative process that leads to the product of research and development (an exclusive solution to a technical problem) is the joint effort of pharmaceutical science experts and patent law experts. It involves identifying and managing technical and patent risks as new technical information is being generated.

If pharmaceutical patent experts are faced with a choice between taking a low or a high risk, and the reward they stand to receive is largely independent of which course they follow, or worse is lower if they take a high risk, they will sensibly take the low risk choice.

Drug discovery is an entrepreneurial activity. To be most effective, this activity requires risk taking by experts in pharmaceutical science and experts in pharmaceutical patent law. If the risks are not managed appropriately, many compounds that would make perfectly good drugs may remain hidden or fail to get taken into development. In accordance with the present invention, it is recognised that experts in pharmaceutical patent law need to operate in an environment where creative thinking and exercise of fine judgement on risk is rewarded, not punished. How few new businesses would be started today if the founders were unable to secure the benefits of limited liability status?

The present invention provides an improved method of conducting drug discovery, which method focuses resources optimally on the target of generating exclusive solutions to technical problems.

Accordingly, the present invention provides a method of identifying a patentable candidate for clinical development as a drug, which comprises the steps of:

selecting a first compound which is a biologically active compound,

identifying one or more properties that if possessed by the first compound would in the case of each property pose a technical problem potentially soluble by a compound embodying a structural modification to the first compound,

identifying one or more candidate compounds, each embodying a structural modification to the first compound, selecting one or more combinations of a said candidate compound and a said technical problem,

submitting said one or more combinations for generation of test data evidencing solving the respective technical problem, and

submitting a patent application describing the technical problem and the test data,

wherein said steps are performed by an expert in pharmaceutical science and an expert in pharmaceutical patent law working in a collaboration in which said experts each accept no responsibility for any of the risks of failure of said experts to create and maintain said patent rights.

Following this method increases the probability of discovering a compound that possesses a desired biological activity and is patentable, thus increasing the rate of production of drug candidates for clinical development (compared with the known method in which an expert in pharmaceutical patent law acts only in an advisory capacity). The method permits the two experts to jointly conceive of combinations of candidate compounds and technical problems, and use their powers of judgement to select combinations for test. Following the method results in several advantages over the known method. It facilitates conception and testing of combinations of candidate compounds and technical problems that would not have been conceived and selected for test in the known method. It reduces waste of resources on the synthesis and testing of compounds that have a low probability of being identified as being patentable. It also optimally focuses resources on comparative testing (for the purposes of demonstrating patentability), reducing the risk of performing unnecessary tests and the risk to of having to perform further comparative tests later (when any resources needed to perform the tests may no longer be readily available). In being relieved of accountability for assessing patentability incorrectly, the expert in pharmaceutical patent law is able to take more risk, and thus combinations of candidate compounds and technical problems that might otherwise have been discounted are advanced for further evaluation.

In effect, the brain of the expert in pharmaceutical patent law is being used as a component of an industrial assay in the same way that a protein, such as an enzyme or receptor, a cell or an animal model is used in discovery research.

It will be appreciated that the collaboration between the expert in pharmaceutical science and the expert in pharmaceutical patent law necessitates some form of agreement between them regarding the benefit that each derives from the collaboration. Moreover, since they are under no obligation towards one another to protect and maintain the patent rights arising out of performance of the method, this benefit must take the form of a shared interest in the patent rights.

Generally, under national laws, the patent rights in an invention belong to the inventor or the inventor's successor in title, unless the inventor has agreed otherwise prior to the invention being made. Unfortunately, national laws generally do not provide a clear definition of what an inventor is. If one person has conceived of a compound, how it may be made and how it may be used, another person who conceives a first property of the compound to evidence its patentability may not be found to be a co-inventor. Conceiving a compound as a solution to a technical problem gives rise to an invention. Whether or not an invented compound is patentable depends upon whether or not it provides what a decision-maker operating the global patent system would consider a non-obvious solution to a properly formulated technical problem. In the method according to the present invention, an expert in pharmaceutical science and an expert in pharmaceutical patent law collaborate to identify patentable compounds, but the inventorship of compounds identified following the method according to the present invention may or may not be found to have been joint. If the experts wish to ensure that they have joint ownership in all patent rights arising in performance of the method, they will normally wish to enter into some form of agreement that provides for such joint ownership.

The rights and obligations of joint owners of patent rights differ between national laws. Depending upon the particular national law, joint owners of a patent application or patent may or may not be permitted to grant licenses under the patent application or patent, or assign a share in it, without the consent of the other. It is advantageous for patent rights to be owned by a single business entity.

In one embodiment, the experts agree to assign the patent rights arising in the course of performance of the method to a business entity commonly owned by said experts, and preferably also controlled by said experts, which business entity accepts no responsibility for any of the risks of failure of said experts to create and maintain said patent rights. The commonly owned business entity may be, for example, a partnership or a corporation in which the experts have an interest, for example each owns stock, or options to purchase stock. Said business entity may engage in the development of clinical candidates identified by the method according to the invention, may seek to license rights under the patents or may seek to be sold to an investor. In a business entity controlled by said experts, said experts will have power to decide whether the company may grant a license under the patents or be sold. Common ownership with control provides the experts with an optimal incentive to collaborate in an entrepreneurial way, maximising the productivity of the method according to the invention.

Investors contemplating investing in the development of any compound identified by the method according to the present invention may wish to seek the advice of independent experts in pharmaceutical science and pharmaceutical patent law, for example prior to taking a decision to take a compound into clinical development, to taking a license under the patent rights protecting a compound or to purchasing the business entity. Such independent experts may carry professional indemnity insurance. All risk of failure of the experts employed in the method according to the invention to create and maintain said patent rights would be assumed by said investors.

In accordance with the invention, the first compound can be a known compound; that is to say a compound that has been disclosed to the public (in a patent law sense), or a novel compound, that is a compound that has not been disclosed to the public. In one embodiment of the invention, the first compound is a known compound. Those skilled in the art of assessing patentability will appreciate that patent examiners and patent judges normally assess the patentability of a claimed compound by considering whether or not the claimed compound provides a non-obvious solution to a technical problem posed by a known compound, and in particular the structurally closest known compound possessing the same biological activity.

Accordingly, in one embodiment, the first compound is the known compound that is structurally closest to the compound for which patent application is sought in the method according to the present invention.

The known compound can be a compound that has not yet been evaluated in phase I clinical trials or that has been or is being evaluated in phase I, phase II or phase III clinical trials. A known compound in development may have been given an approved generic name. The known compound can be the active ingredient of a commercial drug. In this case, in one embodiment, the first compound is not the known compound that is structurally closest to the compound for which patent protection is sought in the method according to the present invention. In this embodiment, the one or more properties that if possessed by the first compound would in the case of each property pose a technical problem potentially soluble by a compound embodying a structural modification to the first compound is a property known to be possessed by the first compound but not known to be possessed by the structurally closest known compound possessing the same biological activity. For example, the commercial drug and the structurally closest known compound may be known to possess the same biological activity, but the commercial drug is known to possess a side effect that is not known to be possessed by the structurally closest known compound, perhaps because it has not yet been conceived and tested for. Those skilled in the art of assessing patentability will appreciate that in this special case, patent examiners and patent judges may assess the patentability of a claimed compound by considering whether or not the claimed compound provides a non-obvious solution to the technical problem posed by the commercial drug, not the structurally closest known compound.

In one embodiment, the one or more properties are from 1 to 10, for example from 2 to 8, such as two, three, four, five or six properties. It will be appreciated that each property equates to a different technical problem, and requires a different test to demonstrate that the technical problem has been solved.

The technical problem may be a known problem, or an inherent but hitherto unknown problem.

The method may further comprise the steps of selecting one or more combinations of the first compound and a said technical problem and submitting the first compound for generation of test data evidencing failure to solve the respective technical problem.

The technical problem may be, for example, to increase potency, decrease potency (some very highly potent drugs are very difficult to formulate), decrease a side effect (e.g. liver toxicity, nephrotoxicity, raising or lowering of heart rate or blood pressure, raising or lowering of breathing rate, headache, irritation or pain at site of administration, irregular heartbeat, anemia, wheezing, sore throat, tremors, convulsions, depression, anxiety, constipation, diarrhea, nausea, dyspepsia, vomiting, cough, sleeplessness, drowsiness, dry mouth, taste disturbance, vision disturbance, skin rash, sweating, hyperglycaemia, hypoglycemia, oedema, alopecia, hypersensitivity, nasal congestion, dependence/addiction, mutagenicity, fever, bruising, menstrual irregularities, weight loss, weight gain, appetite suppression and impotence), increase duration of action, reduce duration of action, shorten onset of action time, increase bioavailability, increase metabolic stability, increase storage stability, enable a different route of administration (e.g. oral, inhalation, transdermal, injection), enable administration in additional situations (e.g. before, during or after meals, away from a healthcare practitioner, such as away from a hospital, with or without particular substances, such as particular foods), improve performance of another drug or reduce adverse interaction with another drug.

In another embodiment, each of the one of more candidate compounds possesses qualitatively the same pharmacodynamic properties as the biologically active compound; i.e. acts at the same biological target. Candidate compounds in this embodiment may be selected based upon a conception that they will possess the same pharmacodynamic properties. It is not an essential feature of the present invention that such properties are known at the time that the candidate compounds are identified or selected.

In another embodiment, the technical problem is pharmacokinetic, i.e. is unrelated to the way in which the first compound acts at its biological target. It will be appreciated that the term “pharmacokinetic” is a term of art. It essentially concerns what the body does to the drug, whereas a “pharmacodynamic” effect concerns what the drug does to the body. (See, for example, Chapter 1 of Goodman & Gilman's The Pharmaceutical Basis of Therapeutics Ninth Edition, Mc Graw Hill, 1996 or Chapter 8 of Pharmacology, Fifth Edition; H. P. Rang. et al., published in 2003 by Elsevier Science Limited). Technical problems that are pharmacokinetic include problems related to the absorption, distribution, metabolism and clearance of a drug. Pharmacokinetic problems in a drug are commonly addressed by pharmacists, who seek appropriate formulations of the drug, for example formulations that increase bioavailability, afford sustained release, protect a drug against exposure to the acidic environment of the stomach, etc. However, some pharmacokinetic problems arise after a drug has been released from the formulation containing it, and are due to effects of the body on the drug after a drug has entered into systemic circulation. They may affect the efficacy and/or the safety (side effects) of the drug.

Each structural modification to the first compound may be any structural modification conceived by the experts having regard to the technical problem that has been identified. They can, for example, correspond with replacing one, two or three (such as one) hydrogen atoms, each hydrogen atom being replaced with an atom or group selected independently from a halogen atom, such as a fluorine, chlorine, bromine or iodine atom; an alkyl group, such as a methyl, ethyl, propyl, isopropyl or butyl or isobutyl group; a cycloalkyl group such as a cyclopropyl group; a cycloalkylalkyl group, such as a cyclopropylmethyl group; a benzyl group; an alkenyl group, such as ethenyl group; an alkynyl group, such as an ethynyl group; a hydroxyalkyl group, such as a hydromethyl group, a 2-hydroxyethyl group or a 1,2-dihydroxyethyl group; a haloalkyl group, such as a trifluoromethyl group; a nitro group; a cyano group; a hydroxy group; an alkoxy group, such as methoxy group or an ethoxy group; a cycloalkoxy group, such as a cyclopropoxy group; an alkanoyl group, such as an ethanoyl group; a carboxyl group; an alkoxycarbonyl group such as a methoxycarbonyl or ethoxycarbonyl group; an amino group; an alkylamino group such as a methylamino group or an ethylamino group; a dialkylamino group, such as a dimethylamino group; an azacycloalkyl group such as pyrrolidinyl or piperidinyl; piperazinyl; morpholino; an alkanoylamino group, such as ethanoylamino; a benzoylamino group; an aminocarbonyl group; an alkylaminocarbonyl group, such as methylaminocarbonyl or ethylaminocarbonyl; a dialkylaminocarbonyl group, such as dimethylaminocarbonyl; pyrrolidinylcarbonyl; piperidylcarbonyl, piperazinylcarbonyl; benzamido; an alkylthio group, such as methylthio; an alkylsulfinyl group, such as methylsulfinyl (S(→O)CH₃); an alkylsulfonyl group, such as methylsulfonyl (S(═O)CH₃); SO₂NH₂, an alkylsulfonamido group, such as methylsulphonamido; an alkylaminosulfonyl group, such as methylaminosulphonyl; a phenyl group; an alkylphenyl group, such as o-, m- or p-methylphenyl; an alkoxyphenyl group such as o-, m- or p-methoxyphenyl; a halophenyl group, such as o-, m- or p-fluoro, chloro, bromo or iodophenyl; furyl such as 2-furyl; thienyl, such as 2-thienyl; imidazolyl such as 2-imidazolyl; pyridyl, such as 2-, 3- or 4-pyridyl; benzoyl; benzyl; phenoxy, phenylthio or a phenylamino group. This corresponds to the situation where the first compound can be represented by the formula R^{a}Hₙ, in which n represents 1, 2 or 3, and the candidate compound represents R^{a}Z^{a}ₙ, in which Z^{a} represents a replacement atom or group, for example as described hereinabove.

In another embodiment, the first compound can be represented by the formula R^{b}Z^{b}ₙ in which Z^{b} represents an atom or group, for example as described hereinabove for Zₐ, and the candidate compounds can be represented by the formula R^{a}Hₙ in which n is 1, 2 or 3. In this case, one, two or three atoms of groups has been replaced by a hydrogen atom.

In yet another embodiment, a structural modification can correspond with a candidate compound in which two hydrogen atoms and the bonds connected to them in a first compound are replaced with a single bond, so as to form a multiple bond or a bond forming a cyclic structure.

In yet another embodiment, a structural modification can correspond with a candidate compound in which two hydrogen atoms have been added across a multiple bond or across a single bond in a cyclic group to afford an acyclic structure.

A candidate compound can be in any stereoisomeric form, for example in the form of a cis or a trans isomer, a racemic mixture or an enantiomer. It can also be in the form of a salt, for example a salt formed with an acid or a base, or an internal salt, as for example in a quaternary ammonium compound. In another embodiment of the invention a candidate compound is a stereoisomer of the first compound, for example a single enantiomer.

In one embodiment, the one or more candidate compounds number at least 2, for example at least 5, such as from 2 to 100 or 5 to 50.

It will be appreciated by those skilled in the art of medicinal chemistry that candidate compounds can readily be prepared following methods known or analogous to methods known in the art. A convenient method may be to modify a method known for the preparation of the first compound. Such methods can readily be found by searching for scientific papers and patent specifications disclosing such compounds. Some candidate compounds will be known and readily available from commercial sources, such as ALDRICH™.

In one embodiment, the selected one or more combinations of a said candidate compound and a said technical problem exclude the case where the technical problem is to provide a compound having the same biological activity as the first compound. In other words, a candidate compound is not selected for test to see if it possesses the same biological activity as the first compound before the candidate compound has been tested to see if it solves a different technical problem. Resources are not invested testing a compound for its biological activity unless and until after it has been found to solve a different problem evidencing patentability.

In another embodiment, the number of technical problems in said one or more combinations of a said candidate compound and a said technical problem is at least 2, for example at least 3, 4, or 5, such as from 2 to 10.

In yet another embodiment, the number of candidate compounds in said one or more combinations of a said candidate compound and a said technical problem is at least 2, for example at least 3, 4, or 5, such as from 2 to 10.

In one embodiment, each technical problem in said one or more combinations of said candidate compound and a said technical problem is a pharmacokinetic problem. Each of the one or more candidate compounds in the selected combinations may be expected to possess qualitatively the same pharmacodynamic properties as the first (biologically active) compound. The fact that a candidate compound does possess pharmacodynamic properties qualitatively the same as the first (biologically active) compound may not be established (confirmed by testing) until later, for example only for candidate compounds that have been found to solve a pharmacokinetic problem. Thus, resources are not wasted testing candidate compounds unnecessarily.

Tests and apparatuses suitable for use in the tests are known or can readily be devised and assembled by those skilled in the art, in particular biologists, pharmacologists and toxicologists experienced in assaying for properties of biologically active compounds. The tests may include enzyme-based tests, receptor binding tests, antibacterial and antiviral tests, whole cell tests (e.g. natural or genetically engineered cells, such as hamster kidney cells, expressing a particular receptor protein), isolated tissue tests (e.g. using tissue from the brain, spinal chord, peripheral nervous system, skeletal muscle, esophagus, stomach, intestine, lung, skin, liver, gall bladder, pancreas, adrenal gland, thyroid gland, parathyroid gland, pituitary gland, prostate gland, bladder, urethra, kidney, tongue, nose, eye, ear, throat, mouth, breast, uterus, testes, ovary, penis, bone, blood vessel, heart, blood, plasma, spinal chord fluid, isolated organ tests and in-vivo (animal model) tests. An apparatus may comprise said biological material. In another embodiment, an apparatus may comprise a device for measuring a response of a biological material, cell or organism (including a human or non-human animal) to exposure to a candidate compound. In the case of an organism, such a device may be adapted to measure, for example, blood pressure, heart rate, heart rhythm, breathing rate, lung performance, body temperature, muscle contraction or relaxation, or brain activity. In yet another embodiment, an apparatus can comprise a device for detecting or measuring the presence of a substance (such as a candidate compound, enzyme substrate, enzyme product) in a sample, for example in or taken from a test system in which a candidate compound has been tested. When the test system is a human or non-human animal body, the sample may be, for example, blood, blood plasma or urine.

The generation of test data may be performed, for example, by one of more of the experts, by one or more people working under the supervision of the experts, or by an outside contractor.

It will be appreciated that test data generated from the testing of a candidate compound may be used to guide the identification and selection of one or more further combinations of a candidate compound and a technical problem. For example, the first compound is a compound of formula RH, test results for a compound RF and one technical problem are generated, then test results are generated for another compound R—OH and the same or a different technical problem, then a patent application is filed for the R—OH compound describing the technical problem(s) solved by this compound and the test results.

The patent application describing the technical problem and the test data can be submitted to a Patent Office in paper form or in electronic form. It can be prepared by the expert in pharmaceutical patent law working in the collaboration with the expert in pharmaceutical science. It contains an enabling description of the claimed invention, of the technical problem solved by the claimed invention, of the test used to demonstrate that the problem has been solved by the claimed invention, and the test data (optionally in summary form only).

In the method according to the present invention, it is preferred, but not essential that the patent application be prepared by the expert in pharmaceutical patent law, rather than a different professional representative who is under a duty of care to protect the patent rights. The preparation of a patent application can be a time when significant further innovation takes place, as each aspect of an invention is carefully thought through. Tasks that are unrelated to the method of the invention such as the tracking of due dates, filing of documents at a Patent Office, payment of official fees, etc, can all be outsourced to a different professional representative who is under a duty of care to protect the patent rights. Many Patent Offices will only deal with professional representatives that are registered to practice before them, in which case certain responsibilities for prosecuting applications will have to be outsourced to a different professional representative who is under a duty of care to protect the patent rights.

The patent application can be an initial (priority) patent application.

It will be appreciated that, in accordance with the Paris Convention, it is normal to submit at least a first priority patent application, and then within 12 months file a subsequent patent application claiming priority from said at least first priority and any other priority patent applications. The subsequent patent applications submitted to a Patent Office are searched and examined, but this procedure can take many years. Receipt of a positive examination report from the Patent Office provides independent confirmation that the invention claimed in the patent application is considered to be patentable. However, those skilled in the art of pharmaceutical patent law will appreciate that no assurance can ever be obtained that an invention is patentable!

In one embodiment of the method, the method comprises submitting an international patent application. International patent applications are searched relatively quickly, and an initial report on the patentability of the claimed invention is provided.

In another aspect, the present invention provides a method of identifying a patentable candidate for clinical development as drug, in which an expert in pharmaceutical science and an expert in pharmaceutical patent law work in a collaboration in which said experts each accept no responsibility for any of the risks of failure of said experts to create and maintain said patent rights.

In yet another aspect, the present invention provides a kit of parts useful in the method of the invention, which kit comprises:

one or more candidate compounds, each embodying a structural modification to a first compound which is a biologically active compound;

a first storage medium comprising a database adapted to receive and containing test data capable of being generated by testing selected one or more combinations of a said candidate compound and one or more technical problems formulated with respect to said first compound;

apparatus for generation of test data evidencing solving a said technical problem by a said candidate compound in at least one of said combinations;

a second storage medium comprising a document for submission in a patent application, which document contains test data generated by said test; and

a third storage medium containing a document evidencing an agreement between an expert in pharmaceutical science and an expert in pharmaceutical patent law to work in a collaboration in which said experts each accept no responsibility for any of the risks of failure of said experts to create and maintain patent rights in any said candidate compound.

The first storage medium can be paper and ink, or an electronic storage medium, as in a computer. The database will be configured to record each selected combination of a said candidate compound and a said technical problem, and the test data obtained from testing the combination.

The apparatus for generation of test data evidencing solving a said technical problem by a said candidate compound in at least one of said combinations can comprise a protein (such as an enzyme or receptor), bacterium, virus, whole cell, tissue, organ or whole animal, as described hereinabove for the method aspect of this invention.

The second storage medium can be paper and ink, or an electronic storage medium, as in a computer. Commonly, patent applications and subsequently filed documents are provided to Patent Offices on an electronic storage medium.

In one embodiment, the third storage medium contains a document evidencing an agreement between said expert in pharmaceutical science and said expert in pharmaceutical patent law to assign the patent rights arising in the course of performance of the method to a business entity commonly owned by said experts, which business entity accepts no responsibility for any of the risks of failure of said experts to create and maintain said patent rights. In one example of this embodiment, the business entity is controlled by said experts.

In one embodiment, the kit comprises at least 2, such as at least 5 or at least 10 candidate compounds.

In another embodiment, the kit further comprises the said first compound.

In yet another embodiment, the kit comprises at least two apparatuses each for generation of test data evidencing solving a different said technical problem by a said candidate compound in at least one of said combinations. In an example of such an embodiment, each apparatus is adapted for generation of test data evidencing solving a different pharmacokinetic technical problem.

### DEFINITION OF TERMS

Expert in pharmaceutical science: a person who is educated to at least the level of a University degree in a pharmaceutical science, such as biology, chemistry, pharmacy or pharmacology, and who has been practicing in the field of drug discovery or development for at least 5 years, and preferably at least 10 years, for example at least 20 years. The expert may be, for example, a medicinal chemist.

Expert in pharmaceutical patent law: a person registered (or formerly registered) to practice before a Patent Office in at least one country or region as a patent agent or patent attorney, a (former) patent examiner of a patent office, or a (former) patent judge, who has been practicing (working as a professional representative or for a Patent Office or Court) in the field of pharmaceutical patents (patents protecting medicinal products comprising a drug) for at least 5 years, and preferably at least 10 years, for example at least 20 years. An expert may have drafted the specifications for granted patents protecting many, for example at least 25, at least 50 or at least 100 different pharmaceutical inventions. The Patent Office may be, for example the United States Patent and Trademark Office, the European Patent Office, the Canadian Patent Office, the Australian Patent Office, the New Zealand Patent Office, the Eurasian Patent Office, the Russian Patent Office, the South Korean Patent Office, the Japanese Patent Office, the Chinese Patent Office, the Indian Patent Office, the United Kingdom Patent Office, the French Patent Office, the Swedish Patent Office, the Norwegian Patent Office, the Norwegian Patent Office or the German Patent Office. In one embodiment, the expert is (or was) registered to practice before one or both of the United States Patent and Trademark Office and the European Patent Office. It will be appreciated that persons registered to practice before a Patent Office generally possess a scientific qualification. In one embodiment, the expert in pharmaceutical patent law is educated to at least the level of a University degree in a pharmaceutical science, such as biology, chemistry, pharmacy or pharmacology, preferably chemistry.

As used herein, patent protection for a compound includes protection conferred by any permissible claim type, including product, method of treatment, first or second medical use, pharmaceutical composition and kit claims.

The following Examples illustrate the invention.

### Example 1

A medicinal chemist (an expert in medicinal science) and an expert in pharmaceutical patent law (a person qualified to practice before the United States Patent and Trademark Office who has been in practice for over 20 years and has drafted the specifications for granted patents protecting more than 25 different pharmaceutical inventions) agree to collaborate to identify a patentable candidate for clinical development. They agree that each of them will accept no responsibility for any failure of said experts to create and maintain said patent rights, and further agree to assign any patent rights arising in the course of the collaboration to a business entity commonly owned and controlled by said experts, which business entity accepts no responsibility for any of the risks of failure of said experts to create and maintain said patent rights. The agreement is stored on a paper storage medium as an original, signed document.

The active ingredient in a known drug has the formula R—H in which R represents an organic group having a particular structure. The drug is known to act as an inhibitor of a particular enzyme, and to be useful in the treatment a particular disease. Quite a lot is known about the structure activity relationships of the structural class to which the drug belongs. Generally, but not always, compounds containing the structural feature X present in the group R have been found to be act as inhibitors of the enzyme.

The experts collaborate to identify properties that if possessed by the first compound would in the case of each property pose a technical problem to be solved by a novel compound. These properties include certain undesirable side effects that might arise when the first compound is used in particular circumstances, for example when the compound is administered to a patient having impaired renal function, or undergoing treatment for a different condition with another class of drug, such as an anti-platelet agent (for whom an increase in coagulation time could cause internal bleeding). The nephrotoxicity is a pharmacokinetic effect, caused by accumulation of toxic levels of the first compound in the kidney. An effect connected with use of an antiplatelet agent is a pharmacodynamic effect that arises due to inhibition by the first compound of another, related enzyme in the blood coagulation cascade (i.e. the first compound is a non-selective enzyme inhibitor).

The medicinal chemist and expert in pharmaceutical patent law collaborate to generate combinations of candidate compounds and technical problems. Candidate compounds are identified which are of the formulae R—CH₃, R—F, R—OH, R—OCH₃ and R—CN and are considered in combination with each of the technical problems. The two experts use their judgement to select combinations of candidate compounds and technical problems for test. These are:—

| Candidate | |
|---|---|
| Compound | Technical Problem |
| R—CH₃ | Reduced Nephrotoxicity |
| R—F | Reduced Nephrotoxicity |
| R—F | No increase in coagulation time |
| R—OH | Reduced Nephrotoxicity |
| R—OCH₃ | Reduced Nephrotoxicity |
| R—CN | No increase in coagulation time |

The tests make use of a first apparatus comprising an animal model for nephroxicity (see, for example, WO01/82971) and a second apparatus comprising an apparatus for measuring blood coagulation time (see for example WO01/96323).

It is found, using the first apparatus that the compound of formula R—F causes reduced nephrotoxicity compared with the compound of formula R—H, but not any of the other candidate compounds. The tested combinations and test results are stored in an electronic database on a computer. The compound of formula R—F is subsequently tested for activity as an inhibitor of the enzyme, and is found to possess activity similar to that of the compound of formula R—H.

The expert in pharmaceutical patent law, working in collaboration with the expert in pharmaceutical science, drafts a patent specification. The patent specification describes the technical problem of nephrotoxicity associated with the first compound, and provides a description of the test and test results that evidence that the compound of formula R—F solves the problem. The patent specification is stored on a computer as an electronic document.

A patent application is filed claiming the compound of formula R—F, supported by the test data demonstrating that the compound possesses reduced nephrotoxicity. A patent is eventually granted for the compound.

The compound of formula R—F is taken into clinical development. In clinical trials, the reduced nephrotoxicity of the compound is confirmed. The compound is accepted by the medical profession and used as the drug of choice for patients having impaired renal function.

A generic company challenges the validity of the patents, arguing that the compound was obvious as an inhibitor of the enzyme. The judge rejects the challenge, based upon evidence that the compound has become the drug of choice for patients having impaired renal function.

### Comparative Example 1

The active ingredient in a known drug has the formula R—H in which R represents an organic group having a particular structure. The drug is known to act as an inhibitor of a particular enzyme, and to be useful in the treatment a particular disease. Quite a lot is known about the structure activity relationships of the structural class to which the drug belongs. Generally, but not always, compounds containing the structural feature X present in the group R have been found to be act as inhibitors of the enzyme.

A medicinal chemist (an expert in medicinal science) identifies candidate compounds of the formulae R—CH₃, R—F, R—CN and R—CH₂NH(C═O)Y in which Y represents pyrid-2-yl substituted at the 3-position by methyl or ethyl. He or she submits these for test as enzyme inhibitors. The results demonstrate the compounds are all active, at a level more or less similar to the compound R—H.

The medicinal chemist consults a patent attorney working in private practice for advice on protection of the compounds. The patent attorney advises the medicinal chemist that enforceable patent protection is unlikely to be obtainable for the compounds, based upon the available data.

None of the compounds is advanced into clinical development.

### Comparative Example 2

The active ingredient in a known drug has the formula R—H in which R represents an organic group having a particular structure. The drug is known to act as an inhibitor of a particular enzyme, and to be useful in the treatment a particular disease. Quite a lot is known about the structure activity relationships of the structural class to which the drug belongs. Generally, but not always, compounds containing the structural feature X present in the group R have been found to be act as inhibitors of the enzyme.

A medicinal chemist (an expert in medicinal science) employed by a business identifies candidate compounds of the formulae R—CH₃, R—F, R—CN and R—CH₂NH(C═O)Y in which Y represents pyrid-2-yl substituted at the 3-position by methyl or ethyl. He or she submits these for test as enzyme inhibitors. The results demonstrate the compounds are all active, at a level more or less similar to the compound R—H.

The medicinal chemist directs an in-house patent attorney to prepare and file a patent application claiming the compounds of the formulae R—CH₂NH(C═O)Y in which Y represents pyrid-2-yl substituted at the 3-position by methyl or ethyl.

A patent application is filed, and one of the compounds is selected for progression as a clinical candidate. Eventually, the patent application is examined. The application is rejected on the grounds that the compounds are obvious as inhibitors of the enzyme, since they contain the group X. The business loses confidence in the compound and abandons the development.

### Example 2

The method of Example 1 is repeated, except that in this case, three pharmacokinetic technical problems are identified: to increase bioavailability, to increase duration of action and to decrease nephrotoxicity. It is known that incorporating an OH group into structurally unrelated compounds has sometimes been found to increase bioavailability.

The medicinal chemist and expert in pharmaceutical patent law collaborate to generate combinations of candidate compounds and technical problems. Candidate compounds are identified which are of the formulae R—CH₃, R—F, R—OH, R—OCH₃ and R—CN and are considered in combination with each of the technical problems. The two experts use their judgement to select combinations of candidate compounds and technical problems for test. These are:—

| Candidate | |
|---|---|
| Compound | Technical Problem |
| R—CH₃ | Increase bioavailability |
| R—F | Reduced Nephrotoxicity |
| R—F | Increased duration of action |
| R—OH | Reduced Nephrotoxicity |
| R—OH | Increased duration of action |
| R—OCH₃ | Reduced Nephrotoxicity |
| R—CN | Increased bioavailabilty |

The compound of formula R—OH is found to possess an increased duration of action. The compound of formula R—OH is subsequently tested for activity as an inhibitor of the enzyme, and is found to possess activity similar to that of the compound of formula R—H.

A patent application is filed claiming the compound of formula R—OH, supported by the test data demonstrating that the compound possesses increased duration of action. A patent is eventually granted for the compound.

The compound of formula R—OH is taken into clinical development. In clinical trials, the increased duration of action of the compound is confirmed. It needs to be taken only once per day, whereas the first compound needs to be taken four times per day. The compound is accepted by the medical profession and used as the drug of choice for patients having impaired renal function.

A generic company challenges the validity of the patents, arguing that the compound was obvious as an inhibitor of the enzyme, and further because it was obvious that introducing a hydroxyl group would increase bioavailability. The judge rejects the challenge, based upon evidence that the compound has become the drug of choice for doctors, and there was no precedent in the literature to suggest that incorporating a hydroxyl group would increase duration of action.

### Example 3

The method of Example 1 is repeated, except that in this case, all that is known about the first compound is that it is biologically active. None of its pharmacokinetic properties is known.

In addition to selecting and submitting for test the combinations of candidate compounds and technical problems described in Example 1, the experts also submit the first compound for test in respect of each of the technical problems.

It is found that known compound is nephrotoxic, whereas the compound of formula R—F is not.

1. A method of identifying a patentable candidate for clinical development as a drug, which comprises the steps of:
selecting a first compound which is a biologically active compound,
identifying one or more properties that if possessed by the first compound would in the case of each property pose a technical problem potentially soluble by a compound embodying a structural modification to the first compound,
identifying one or more candidate compounds, each embodying a structural modification to the first compound,
selecting one or more combinations of a said candidate compound and a said technical problem,
submitting said one or more combinations for generation of test data evidencing solving the respective technical problem, and
submitting a patent application describing the technical problem and the test data,
wherein said steps are performed by an expert in pharmaceutical science and an expert in pharmaceutical patent law working in a collaboration in which said experts each accept no responsibility for any of the risks of failure of said experts to create and maintain said patent rights.

2. A method as claimed in claim 1, in which said experts agree to assign the patent rights arising in the course of performance of the method to a business entity commonly owned by said experts, which business entity accepts no responsibility for any of the risks of failure of said experts to create and maintain said patent rights.

3. A method as claimed in claim 2, in which said business entity is controlled by said experts.

4. A method as claimed in claim 1, wherein said biologically active compound is a known compound.

5. A method as claimed in claim 4, in which said known compound is an active ingredient of a commercial drug.

6. A method as claimed in claim 1, in which each of the one of more candidate compounds possesses qualitatively the same pharmacodynamic properties as the biologically active compound.

7. A method as claimed in claim 1, in which at least five candidate compounds are identified.

8. A method as claimed in claim 1, in which the number of technical problems in said one or more combinations of a said candidate compound and a said technical problem is at least 2.

9. A method as claimed in claim 8, in which each technical problem is a pharmacokinetic technical problem.

10. A method as claimed in claim 1, in which the number of candidate compounds in said one or more combinations of a said candidate compound and a said technical problem is at least 2.

11. A method as claimed in claim 1, which further comprises the steps of selecting one or more combinations of the first compound and a said technical problem and submitting the first compound for generation of test data evidencing failure to solve the respective technical problem.

12. A kit of parts useful in the method of claim 1, which comprises:
one or more candidate compounds, each embodying a structural modification to a first compound which is a biologically active compound;
a first storage medium comprising a database adapted to receive and containing test data capable of being generated by testing selected one or more combinations of a said candidate compound and one or more technical problems formulated with respect to said first compound;
apparatus for generation of test data evidencing solving a said technical problem by a said candidate compound in at least one of said combinations;
a second storage medium comprising a document for submission in a patent application, which document contains test data generated by said test; and
a third storage medium containing a document evidencing an agreement between an expert in pharmaceutical science and an expert in pharmaceutical patent law to work in a collaboration in which said experts each accept no responsibility for any of the risks of failure of said experts to create and maintain patent rights in any said candidate compound.

13. A kit as claimed in claim 12, in which the third storage medium contains a document evidencing an agreement between said expert in pharmaceutical science and said expert in pharmaceutical patent law to assign the patent rights arising in the course of performance of the method to a business entity commonly owned by said experts, which business entity accepts no responsibility for any of the risks of failure of said experts to create and maintain said patent rights.

14. A kit as claimed in claim 13, in which said business entity is controlled by said experts.

15. A kit as claimed in claim 12, which comprises at least 5 candidate compounds.

16. A kit as claimed in claim 12, which further comprises the said first compound.

17. A kit as claimed in claim 12, which comprises at least two apparatuses each for generation of test data evidencing solving a different said technical problem by a said candidate compound in at least one of said combinations.

18. A kit as claimed in claim 17, in which each apparatus is adapted for generation of test data evidencing solving a different pharmacokinetic technical problem.

19. A method of identifying a patentable candidate for clinical development as drug, in which an expert in pharmaceutical science and an expert in pharmaceutical patent law work in a collaboration in which said experts each accept no responsibility for any of the risks of failure of said experts to create and maintain said patent rights.
